(19) United States
(12) Patent Application Publication
(10) Pub. No.: US 2009/0161861 A1
(43) Pub. Date: Jun. 25, 2009

(54) DESKTOP APPARATUS

(75) Inventors: Shinichi Yoshida, Hachioji-shi (JP); Tsutomu Hoshino, Otsuki-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/197,954

(22) Filed: Aug. 25, 2008

(30) Foreign Application Priority Data
Dec. 20, 2007 (JP) 2007-329073

(51) Int. Cl. H04M 9/00

(52) U.S. Cl. 379/436

(57) ABSTRACT

A desktop apparatus includes: a base that has a bottom wall and an inclined portion; a front cover that is detachably fixed to the inclined portion and has an apparatus operation panel disposed opposite to the bottom wall; and a plurality of connectors that are provided on the front cover to face the bottom wall. An inclination direction of the apparatus operation panel is changeable by reversing a direction of the inclined portion with respect to the front cover. The front cover includes a connector cover that covers at least an area where the plurality of connectors are provided. The connector cover has a plurality of connection ports at positions corresponding to the plurality of connectors to expose the plurality of connectors. The bottom wall is provided with an opening portion corresponding to the connector cover irrespective of the direction of the inclined portion.

### CROSS-REFERENCE TO RELATED APPLICATIONS

This application is based upon and claims the benefit of priority from Japanese Patent Application No. 2007-329073, filed on Dec. 20, 2007, the entire contents of which are incorporated herein by reference.

### BACKGROUND

1. Field

One embodiment of the invention relates to a desktop apparatus such as a telephone convertible into a state of placing it on the desk and a state of hanging it on the wall.

2. Description of the Related Art

There has been known a telephone convertible into a state of placing it on the desk and a state of hanging it on the wall. In such a kind of telephone, for example, to improve visibility of an apparatus operation panel on which dial buttons are disposed, an inclination direction of the apparatus operation panel is changed at the time of placing it on the desk and hanging it on the wall (see U.S. Pat. No. 5,185,791, for instance).

The telephone disclosed in the above-cited U.S. Pat. No. 5,185,791 includes a base, a makeup cover that covers the base, and a printed circuit board disposed between the base and the makeup cover. The printed circuit board is fixed to a plurality of boss portions protruding from an inner surface of the makeup cover by screws and is integrated with the makeup cover.

A plurality of dial buttons are mounted on the printed circuit board. The dial buttons protrude from the apparatus operation panel of the makeup cover out of the telephone, so that an operator can operate the dial buttons with a finger.

The base has a bottom plate and an inclined surface formed opposite to the bottom plate. The inclined surface is inclined in a direction so as to separate from the bottom plate, as it goes in a direction from one end of the base formed along a depthwise direction to the other end. The makeup cover is detachably fixed to the bottom plate of the base by screws in a state of overlapping with the inclined surface of the base. Accordingly, the apparatus operation panel of the makeup cover is inclined at an angle formed along the inclined surface of the base.

Therefore, it is possible to change the inclination direction of the apparatus operation panel of the makeup cover into two kinds of directions, by reversing the direction of the inclined surface of the base with respect to the makeup cover by 180 degrees. With such a configuration, when the telephone is placed on the desk, the makeup cover is inclined to lower the front side of the apparatus operation panel, and when the telephone is hung on the wall, the makeup cover is inclined to protrude the lower end of the apparatus operation panel from the wall as compared with the upper end thereof.

A connector is mounted on a surface of the printed circuit board close to the base. The connector is, for example, to connect a telephone line connection cable, and is exposed to the bottom of the telephone through a hole formed on the bottom plate of the base.

The connector and the hole are located at the center of the bottom plate, where diagonal lines of the base intersect with each other. For this reason, even when the base is reversed with respect to the makeup cover by 180 degrees, the hole of the base necessarily corresponds to the connector.

In the telephone disclosed in U.S. Pat. No. 5,185,791, the connector is supported by the makeup cover through the printed circuit board. For this reason, the connector can be disposed only at the center of the base, in consideration of reversing the base by 180 degrees according to a using condition.

Accordingly, for example, when the other connector for connecting an external speaker or a headset is additionally installed, it is necessary to attach the other connector to the base and to connect the other connector and the printed circuit board to each other by an exclusive-use cable.

With such a configuration, when the base is reversed by 180 degrees, the connection of the cable between the printed circuit board and the other connector is cut off or reconnected inevitably. As a result, the number of work processes to reverse the base increases, thereby deteriorating workability.

In addition, it is necessary to form a support portion for supporting the other connector on the base, and it is difficult to avoid a complicated configuration of the base. Therefore, the exclusive-use cable is necessary and further the cost of the telephone increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a telephone according to an embodiment of the invention;

FIG. 2 is a side view showing an inclination direction of an apparatus operation panel at the time of placing a telephone on the desk in the partial sectional view, according to an embodiment of the invention;

FIG. 3 is a perspective view showing a positional relation between a bottom wall of a base and a connector cover at the time of placing a telephone on the desk, according to an embodiment of the invention;

FIG. 4 is a perspective view showing a state of detaching a front cover from a base, according to an embodiment of the invention;

FIG. 5 is a perspective view showing a positional relation between a printed circuit board supported by a front cover and a connector cover, according to an embodiment of the invention;

FIG. 6 is a perspective view showing a positional relation between a printed circuit board supported by a front cover and a connector cover, according to an embodiment of the invention;

FIG. 7 is a perspective view showing a positional relation between a bottom wall of a base and a connector cover at the time of hanging a telephone on the wall, according to an embodiment of the invention;

FIG. 8 is a perspective view showing a positional relation between a bottom wall of a base and a connector cover at the time of hanging a telephone on the wall, according to an embodiment of the invention; and

FIG. 9 is a perspective view showing a positional relation between a printed circuit board supported by a front cover and a connector cover, according to an embodiment of the invention.

### DETAILED DESCRIPTION

Various embodiments according to the invention will be described hereinafter with reference to the accompanying drawings. In general, according to one embodiment of the invention, a desktop apparatus including: a base that has a bottom wall and an inclined portion inclined to the bottom wall; a front cover that is detachably fixed to the inclined portion and has an apparatus operation panel disposed opposite to the bottom wall; and a plurality of connectors that are provided on the front cover to face the bottom wall, wherein an inclination direction of the apparatus operation panel is changeable by reversing a direction of the inclined portion with respect to the front cover, wherein the front cover includes a connector cover that covers at least an area where the plurality of connectors are provided in a direction from the base, wherein the connector cover has a plurality of connection ports at positions corresponding to the plurality of connectors to expose the plurality of connectors, and wherein the bottom wall is provided with an opening portion corresponding to the connector cover irrespective of the direction of the inclined portion.

Hereinafter, an embodiment of the invention will be described with reference to the drawings applied to a telephone.

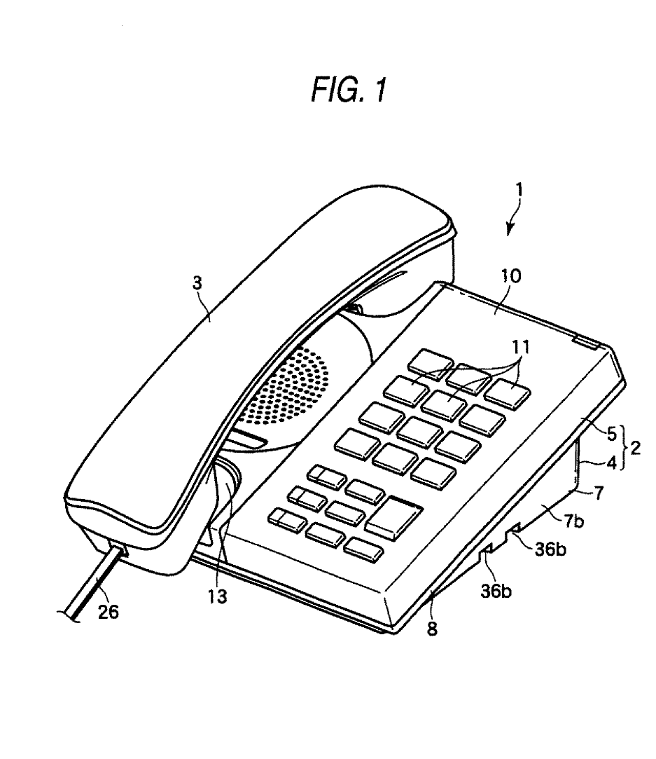

FIGS. 1 to 3 show a telephone 1 that is an example of a desktop apparatus. The telephone 1 according to the present embodiment is generally used at an office or at home. For example, the telephone 1 may be placed on the desk or hung on the indoor wall.

The telephone 1 includes a box-shaped apparatus body 2 and a handset 3. The apparatus body 2 includes a base 4 and a front cover 5.

The base 4 has a bottom wall 6 and a circumferential wall 7. The bottom wall 6 has a square plate shape. In addition, the bottom wall 6 has a first end portion 6a disposed at one end formed along a depthwise direction of the apparatus body 2 and a second end portion 6b disposed at the other end formed along the depthwise direction of the apparatus body 2.

The circumferential wall 7 is erected from a circumferential edge of the bottom wall 6. A front end edge portion of the circumferential wall 7 extends in a circumferential direction of the bottom wall 6. The circumferential wall 7 includes a pair of side wall portions 7a and 7b facing each other in a widthwise direction of the apparatus body 2. The side wall portions 7a and 7b get gradually higher, as they go in a direction from the first end portion 6a to the second end portion 6b of the bottom wall 6. As a result, the protruding end portions of the side wall portions 7a and 7b are inclined with respect to the bottom wall 6.

A flange portion 8 is formed at the protruding end portion of the side of the circumferential wall 7. The flange portion 8 extends in the circumferential direction of the circumferential wall 7, and protrudes from the protruding end portion of the circumferential wall 7 to the outside of the base 4. The flange portion 8 has a square frame shape.

The flange portion 8 is inclined with respect to the bottom wall 6 of the base 4 along the protruding end portions of the side wall portions 7a and 7b. For this reason, in the present embodiment, the flange portion 8 serves as the inclined portion of the base 4.

The front cover 5 covers the base 4 from the upside, joining with the flange portion 8 of the base 4. The front cover 5 has a square apparatus operation panel 10. The apparatus operation panel 10 is disposed opposite to the bottom wall 6 of the base 4.

A plurality of dial buttons 11 and a plurality of regular function buttons 12 are arranged on the right half part of the apparatus operation panel 10. A handset placing portion 13 is formed on the left side of the apparatus operation panel 10. The handset 3 is placed on the handset placing portion 13.

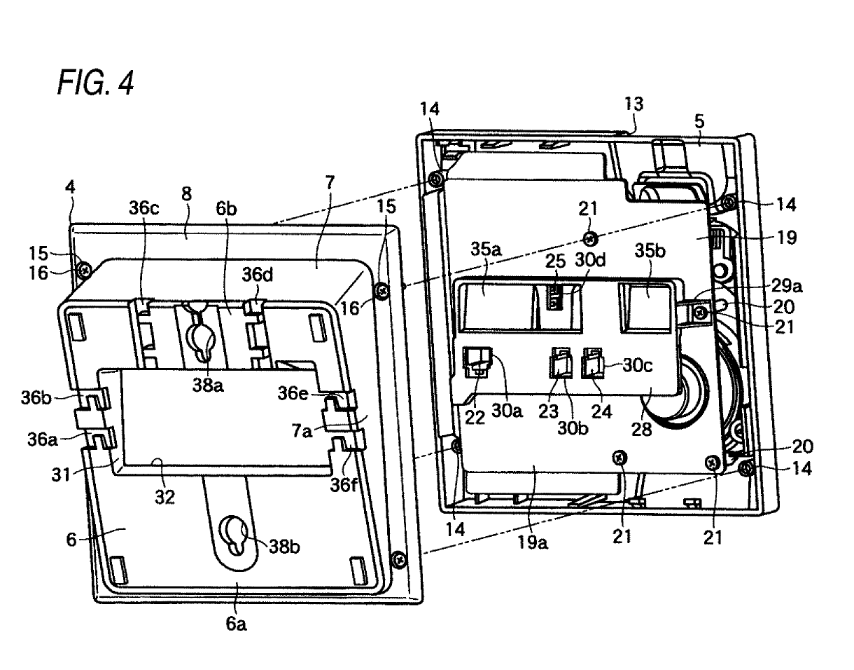

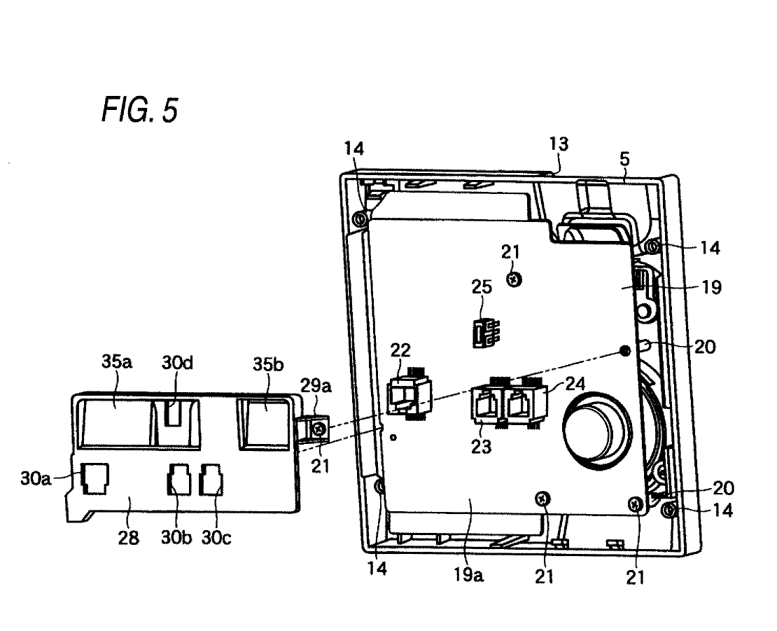

As shown in FIGS. 4 and 5, four boss portions 14 are formed on the inner surface of the front cover 5. The boss portions 14 have screw holes and protrude from the vicinities of four corner portions of the front cover 5 toward the base 4. Through-holes 15 corresponding to the boss portions 14 are formed in the flange portion 8 of the base 4. The through-holes 15 are fitted to the boss portions 14 when the flange portion 8 of the base 4 and the front cover 5 are overlapped with each other.

For this reason, screws 16 are inserted into the through-holes 15 and the screws 16 are fitted to the screw holes of the boss portions 15, thereby coupling the base 4 and the front cover 5. In the coupling state, since the front cover 5 joins with the flange portion 8 serving as the inclined portion, the apparatus operation panel 10 of the front cover 5 is inclined with respect to the bottom wall 6 of the base 4.

Accordingly, the inclination direction of the apparatus operation panel 10 of the front cover 8 can be changed to two types by reversing the direction of the flange portion 8 with respect to the front cover 5 by 180 degrees in a state of detaching the front cover 5 from the base 4.

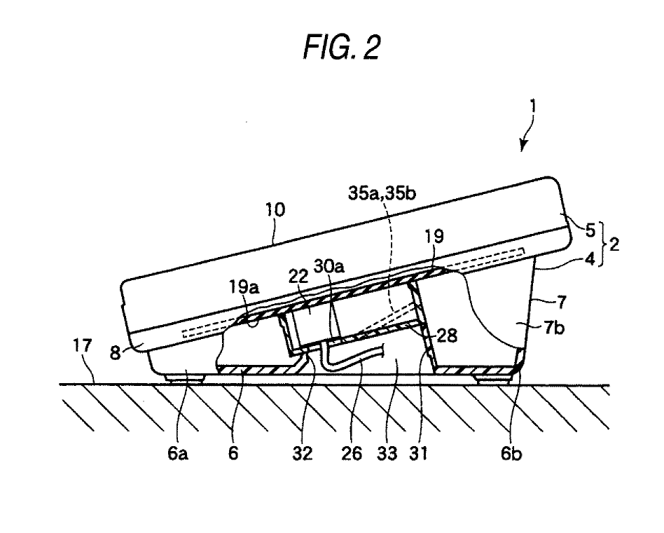

Specifically, as shown in FIG. 2, when the telephone 1 is placed on the placing surface 17 of the desk, the direction of the base 4 is determined to a position the first end portion 6a of the bottom wall 6 on the front side of the operator. In this state, the flange portion 8 of the base 4 is inclined in a direction in which the front side of the operator is low.

For this reason, when the front cover 5 is overlapped with the flange portion 8 and is fixed by the screws 16, the apparatus operation panel 10 of the front cover 5 having the dial buttons 11 and the regular function buttons 12 is inclined to face the operator. Accordingly, visibility of the apparatus operation panel 10 at the time of placing the telephone 1 on the desk is improved.

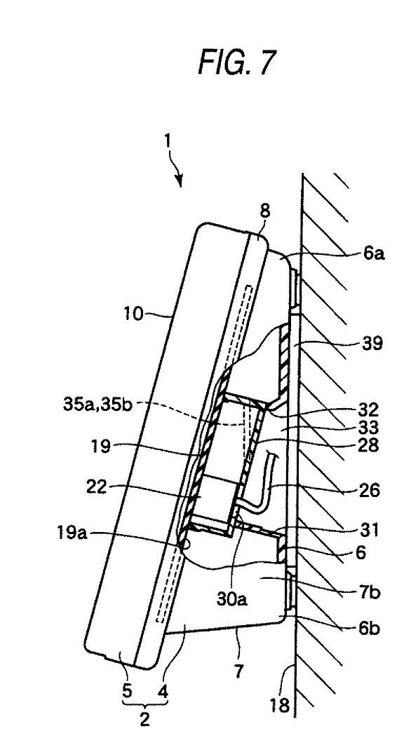

As shown in FIG. 7, for example, when the telephone 1 is hung on the indoor wall 18, the direction of the base 4 is determined to position the second end portion 6b of the bottom wall 6 below the first end portion 6a by reversing the direction of the flange portion 8 of the base 4 by 180 degrees. In this state, the flange portion 8 of the base 4 is inclined closer to the wall 18 as it goes from the second end portion 6h to the first end portion 6a of the bottom wall 6.

For this reason, when the front cover 5 is overlapped with the flange portion 8 and is fixed by the screws 16, the apparatus operation panel 10 of the front cover 5 having the dial buttons 11 and the regular function buttons 12 is inclined to face the operator. Accordingly, visibility of the apparatus operation panel 10 at the time of hang the telephone 1 on the wall 18 is improved.

As shown in FIGS. 2 and 4, a printed circuit board 19 is housed in the apparatus body 2. The printed circuit board 19 has a square shape smaller in size than the front cover 5. The printed circuit board 19 is fixed to front ends of a plurality of boss portions 20 protruding from the inner surface of the front cover 5 by screws 21.

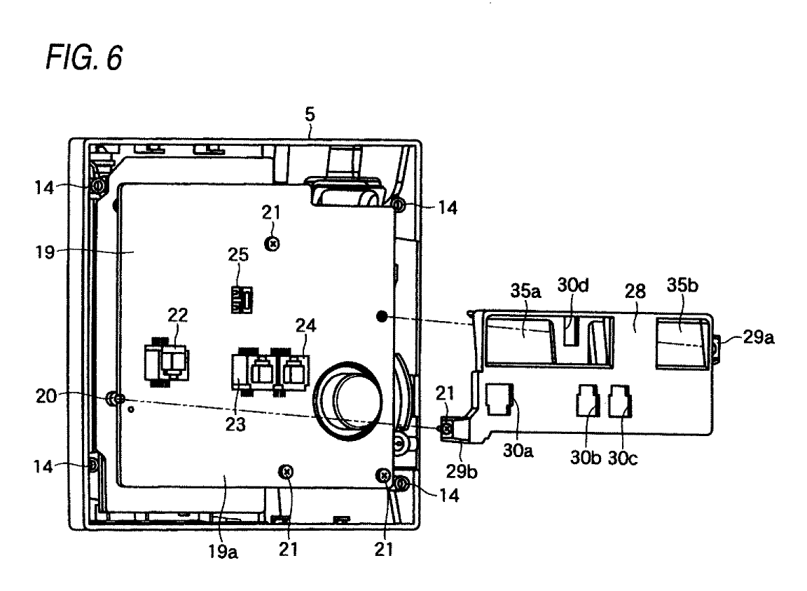

The printed circuit board 19 has a mounting surface 19a facing the bottom wall 6 of the base 4. As shown in FIGS. 5 and 6, first to fourth modular connectors 22, 23, 24, and 25 are mounted on the mounting surface 19a by means of reflow soldering or the like.

The first to third modular connectors 22, 23, and 24 are arranged in a line in the widthwise direction of the apparatus body 2 in the middle portion of the mounting surface 19a. The fourth modular connector 25 is disposed substantially at the center portion of the mounting surface 19a and is adjacent to the second modular connector 23.

The first modular connector 22 is to connect a telephone line connection cable (not shown). The second modular connector 23 is to connect a handset connection cable 26 drawn from the handset 3. The third modular connector 24 is to connect a headset connection cable (not shown). The fourth modular connector 25 is to connect an external speaker connection cable (not shown).

A connector cover 28 is installed on the mounting surface 19a of the printed circuit board 19. The connector cover 28 has a rectangular shape extending in the widthwise direction of the apparatus body 2, and has a size larger than the area where the first to fourth modular connectors 22, 23, 24, and 25 are mounted in the mounting surface 19a of the printed circuit board 19.

First and second fixing pieces 29a and 29b are formed at the connector cover 28. The first fixing piece 29a protrudes from one end of the connector cover 28 in a lengthwise direction thereof toward the printed circuit board 19. The second fixing piece 29b protrudes from the other end of the connector cover 28 in the lengthwise direction toward the printed circuit board 19. The first and second fixing pieces 29a and 29b are fixed to the boss portions 20 of the front cover 5 by screws 21 for fixing the printed circuit board 19.

In the state where the connector cover 28 is fixed to the front cover 5, the connector cover 28 is located at the widthwise center of the apparatus body 2 and at the depthwise center of the apparatus body 2. The connector cover 28 is disposed parallel to the mounting surface 19a of the printed circuit board 19 and covers the first to fourth modular connectors 22, 23, 24, and 25 from the direction of the bottom wall 6 of the base 4.

The connector cover 28 has first to fourth connection ports 30a, 30b, 30c, and 30d. The first to fourth connection ports 30a, 30b, 30c, and 30d are formed at positions corresponding to the first to fourth modular connectors 22, 23, 24, and 25, respectively.

Accordingly, the first to fourth modular connectors 22, 23, 24, and 25 are exposed toward the bottom wall 6 of the base 4 through the first to fourth connection ports 30a, 30b, 30c, and 30d of the connector cover 28.

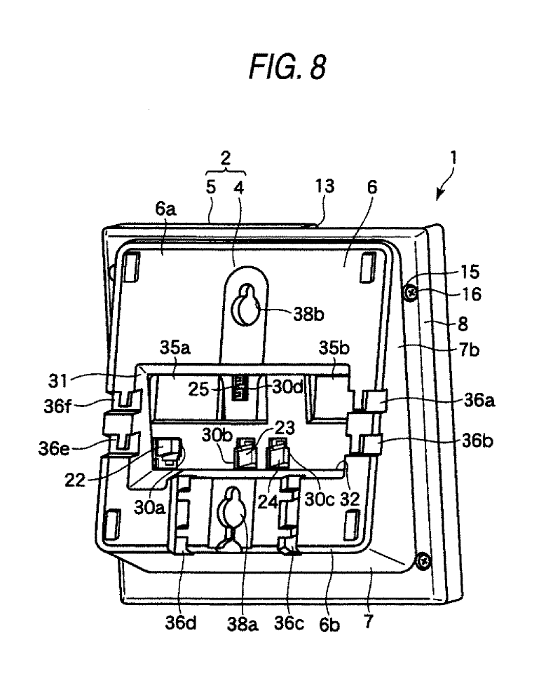

As shown in FIGS. 2, 3, 7, and 8, the base 4 has a recessed portion 31 recessed from the center of the bottom wall 6 to the inside of the base 4. The recessed portion 31 faces the connector cover 28. A square opening portion 32 is formed on the bottom of the recessed portion 31. The opening portion 32 is formed in a size corresponding to the connector cover 28, and an opening edge portion of the opening portions 32 comes into contact with an outer peripheral edge portion of the connector cover 28.

For this reason, the opening portion 32 is closed by the connector cover 28, and the first to fourth connection ports 30a, 30b, 30c, and 30d are located inside the recessed portion 31.

In any case of placing the telephone 1 on the desk and hanging the telephone 1 on the wall 18, the opening portion 32 of the base 4 corresponds to the connector cover 28.

In other words, the opening portion 32 constantly corresponds to the connector cover 28 irrespective of reversing the base 4 with respect to the front cover 5, and exposes the first to fourth connection ports 30a, 30b, 30c, and 30d of the connector cover 28 to the outside of the apparatus body 2.

As shown in FIGS. 2 and 7, in any case of placing the telephone 1 on the desk and hanging the telephone 1 on the wall 18, the recessed portion 31 of the base 4 defines a housing space 33 for housing cables connected to the first to fourth modular connectors 22, 23, 24, and 25.

The connector cover 28 according to the present embodiment has a pair of concave portions 35a and 35b. The concave portions 35a and 35b are exposed to the bottom of the recessed portion 31 and extend to the recessed portion 31. For this reason, capacity of the housing space 33 increases due to the concave portions 35a and 35b. For example, even in a state where all cables are connected to the first to fourth modular connectors 22, 23, 24, and 25, the cable can be reasonably housed in the housing space 33.

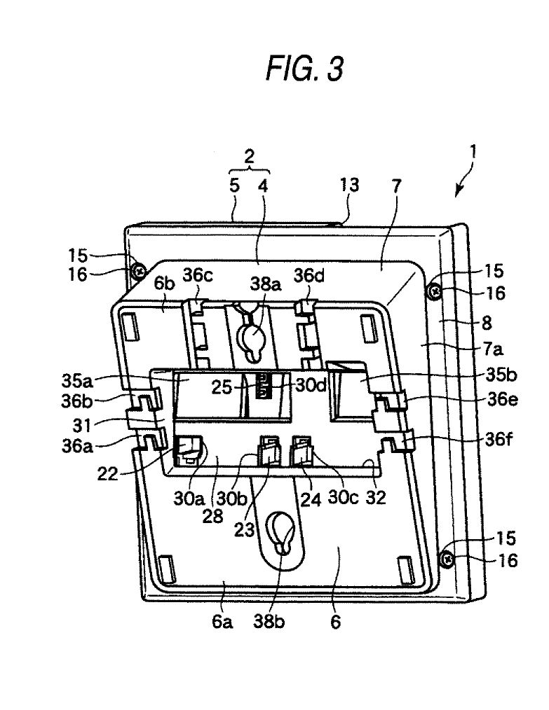

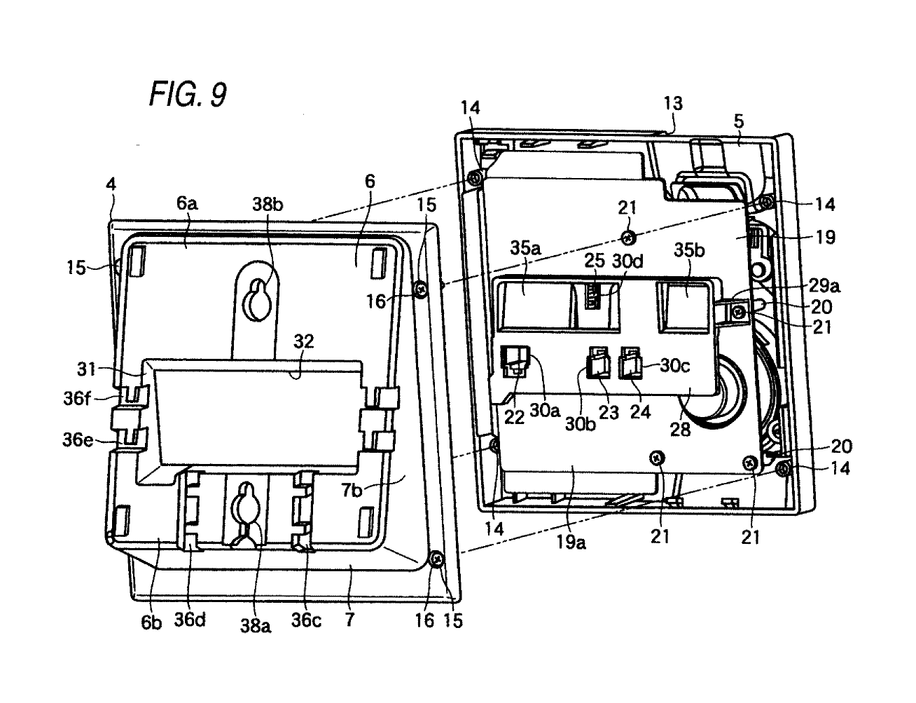

As shown in FIGS. 3, 4, 8, and 9, first to sixth wiring grooves 36a, 36b, 36c, 36d, 36e, and 36f are formed in the bottom wall 6 of the base 4. The first to sixth wiring grooves 36a, 36b, 36c, 36d, 36e, and 36f extend in a radial shape from the opening end of the recessed portion 31 toward the circumference of the base 4, and are opened at the corner portion defined by the bottom wall 6 and the circumferential wall 7. The cable connected to the first to fourth modular connectors 22, 23, 24, and 25 are drawn out of the base 4 from the recessed portion 31 through any one of first to sixth wiring grooves 36a, 36b, 36c, 36d, 36e, and 36f.

A pair of engagement holes 38a and 38b are formed in the bottom wall 6 of the base 4. The engagement holes 38a and 38b detachably engage with metal hangers 39 attached to the wall 18 at the time of hanging the telephone 1 on the wall 18.

As shown in FIG. 2, when the telephone 1 is placed on the desk, the direction of the base 4 is determined to position the first end portion 6a of the bottom wall 6 on the front side of the operator. In this state, when the front cover 5 is overlapped with the flange portion 8 of the base 4 and is fixed by the screws 16, the apparatus operation panel 10 of the front cover 5 having the dial buttons 11 and the regular function buttons 12 is inclined to face the operator.

When the telephone 1 is hung on the wall 18, the fixation of the base 4 and the front cover 5 by the screws 16 is released and the base 4 and the front cover 5 are detached from each other. Next, the base 4 is reversed with respect to the front cover 5 by 180 degrees to reverse the inclination direction of the flange portion 8 with respect to the bottom wall 6 of the base 4 from the direction thereof used on the desk. In this state, the front cover 5 is overlapped with the flange portion 8 of the base 4 and is fixed by the screws 16 and then the direction of the base 4 is determined to position the second end portion 6b of the bottom wall 6 below the first end portion 6a.

Subsequently, the engagement holes 38a and 38b formed in the bottom wall 6 of the base 4 are hung on the metal hanger 39 fixed to the wall 18. Accordingly, the telephone 1 is held on the wall 18, and the apparatus operation panel 10 of the front cover 5 having the dial buttons 11 and the regular function buttons 12 are inclined to face the operator.

According to such a telephone 1, the opening portion 32 of the base 4 corresponds to the connector cover 28 that covers the connector mounting area of the printed circuit board 19 even when the base 4 is reversed in any one direction corresponding to the use type of the telephone 1. Since the connector cover 28 has the first to fourth connection ports 30a, 30b, 30c, and 30d that expose the first to fourth modular connectors 22, 23, 24, and 25 to the recessed portion 31 of the base 4, the positions of the first to fourth connection ports 30a, 30b, 30c, and 30d are irrespective of the position of the opening portion 32 of the base 4.

For this reason, the first to fourth modular connectors 22, 23, 24, and 25 can be installed at any position on the mounting surface 19a of the printed circuit board 19 while allowing the base 4 to be reversed with respect to the front cover 5.

Therefore, when the inclination direction of the apparatus operation panel 10 is changed according to the use type of the telephone 1, it is necessary to perform only the simple work of reversing the direction of the base 4 by 180 degrees, thereby improving workability.

In addition, the opening portion 32 of the base 4 is closed by the connector cover 28 even in the state of reversing the base 4 in any direction. For this reason, the mounting surface 19a of the printed circuit board 19 is not shown through the opening portion 32, and it is possible to prevent foreign substances from being infiltrated into the apparatus body 2.

According to the aforementioned configuration, the first to fourth modular connectors 22, 23, 24, and 25 can be mounted on the mounting surface 19a of the printed circuit board 19 at once by such as reflow soldering. For this reason, it is unnecessary to connect the printed circuit board and the connector to each other by the exclusive-use cable like the conventional art, and thus it is possible to easily mount the first to fourth modular connectors 22, 23, 24, and 25.

In addition, since the first to fourth modular connectors 22, 23, 24, and 25 are mounted on the printed circuit board 19, it is unnecessary to provide the base 4 with a connector supporting portion or to form a connection port for exposing the connectors to the side face of the base 4. As a result, the base 4 has a simple structure, the cost of the telephone 1 can be reduced, and it is possible to keep the appearance of the telephone 1 satisfactory.

In the above-described embodiment, the base of the telephone is hung on the metal hanger attached to the wall at the time of hanging the telephone on the wall, but the base of the telephone may be hung on a metal supporter for holding a modular outlet on the wall.

The desktop apparatus according to the invention is not limited to the office telephone or the home telephone. For example, a base unit of an interphone having a transmitter and a displayer can be embodied similarly.

While certain embodiment of the inventions have been described, this embodiment has been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A desktop apparatus comprising:
a base that has a bottom wall and an inclined portion inclined to the bottom wall;
a front cover that is detachably fixed to the inclined portion and has an apparatus operation panel disposed opposite to the bottom wall; and
a plurality of connectors that are provided on the front cover to face the bottom wall,
wherein an inclination direction of the apparatus operation panel is changeable by reversing a direction of the inclined portion with respect to the front cover,
wherein the front cover includes a connector cover that covers at least an area where the plurality of connectors are provided in a direction from the base,
wherein the connector cover has a plurality of connection ports at positions corresponding to the plurality of connectors to expose the plurality of connectors, and
wherein the bottom wall is provided with an opening portion corresponding to the connector cover irrespective of the direction of the inclined portion.

2. The desktop apparatus according to claim 1, wherein the base has a recessed portion recessed from the bottom wall toward the front cover, and
wherein the opening portion is located at a bottom of the recessed portion.

3. The desktop apparatus according to claim 2, wherein the recessed portion defines a housing space that houses cables connected to the plurality of connectors.

4. The desktop apparatus according to claim 3, wherein the connector cover has concave portions exposed to the recessed portion to put the cables thereinto.

5. A desktop apparatus comprising:
a base that has a bottom wall and an inclined portion inclined to the bottom wall;
a front cover that is detachably fixed to the inclined portion and has an apparatus operation panel disposed opposite to the bottom wall;
a printed circuit board that is supported by the front cover and has a mounting surface facing the bottom wall; and
a plurality of connectors that are mounted on the mounting surface,
wherein an inclination direction of the apparatus operation panel is changeable by reversing a direction of the inclined portion with respect to the front cover,
wherein the front cover includes a connector cover that covers at least an area where the plurality of connectors are mounted in a direction from the base,
wherein the connector cover is disposed on the mounting surface of the printed circuit board,
wherein the connector cover has a plurality of connection ports at positions corresponding to the plurality of connectors to expose the plurality of connectors, and
wherein the bottom wall is provided with an opening portion corresponding to the connector cover irrespective of the direction of the inclined portion.

6. The desktop apparatus according to claim 5, wherein the plurality of connectors are soldered onto the mounting surface of the printed circuit board.

7. The desktop apparatus according to claim 6, wherein the connector cover is supported by the front cover together with the printed circuit board.

8. The desktop apparatus according to claim 7, wherein the base has a recessed portion recessed from the bottom wall toward the front cover, and
wherein the opening portion is located at a bottom of the recessed portion.

9. The desktop apparatus according to claim 8, wherein the recessed portion defines a housing space that houses cables connected to the plurality of connectors.

10. The desktop apparatus according to claim 9, wherein the connector cover has concave portions exposed to the recessed portion to put the cables thereinto.
